(19) United States
(12) Patent Application Publication
(10) Pub. No.: US 2015/0185652 A1
(43) Pub. Date: Jul. 2, 2015

(54) IMAGE FORMING APPARATUS

(71) Applicants: TOSHIBA TEC KABUSHIKI KAISHA, Toshiba (JP); KABUSHIKI KAISHA TOSHIBA, Tokyo (JP)

(72) Inventor: Toshifumi MIMURA, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/145,725

(22) Filed: Dec. 31, 2013

(51) Int. Cl. G03G 15/08

(52) U.S. Cl. CPC G03G 15/0131

(57) ABSTRACT

An image forming apparatus includes a first image forming unit configured to form an image on a medium with a non-decolorizable material, a second image forming unit configured to form an image on a medium with a decolorizable material, and a control unit configured to form the image on the medium with the non-decolorizable material in response to a printing command to form the image on the medium with the decolorizable material.

### FIELD

Embodiments described herein relate generally to an image forming apparatus.

### BACKGROUND

In the related art, there is an image forming apparatus that forms an image with a decolorizable material. Also, there is an erasing apparatus that can erase the image formed with the decolorizable material. The image formed with the decolorizable material can be erased, when the color of the image is decolorized by heating the decolorizable material to a specific temperature. Using a sheet repeatedly by employing such an image forming apparatus and an erasing apparatus leads to conservation of forest resources and a reduction in the amount of carbon dioxide emissions. One type of an image forming apparatus includes an image forming unit that forms an image with the decolorizable material and another image forming unit that forms an image with non decolorizable material. When the decolorizable material or the non-decolorizable material is used up, a printing operation cannot be carried out until the used-up material is replaced.

### DESCRIPTION OF THE DRAWINGS

The accompanying drawings, which are incorporated in and constitute a part of this specification, illustrate an embodiment of the invention and together with the description, serve to explain the principles of the invention.

FIG. 1 is a schematic configuration diagram showing an example of an image forming apparatus according to a present embodiment.

FIG. 2 is a schematic configuration diagram showing an example of an erasing apparatus which erases an image formed with a decolorizable material.

FIG. 3 is a flowchart showing the operations of the image forming apparatus according to the present embodiment.

FIGS. 4 and 5 are examples of interfaces displayed on a control panel when the image forming apparatus according to the present embodiment is operated.

### DETAILED DESCRIPTION

Reference will now be made in detail to the present embodiment of the invention, an example of which is illustrated in the accompanying drawing.

In general, according to one embodiment, an image forming apparatus includes a first image forming unit configured to form an image on a medium with a non-decolorizable material, a second image forming unit configured to form an image on a medium with a decolorizable material, and a control unit configured to form the image on the medium with the non-decolorizable material in response to a printing command to form the image on the medium with the decolorizable material.

A detailed description will be given of the present embodiment below.

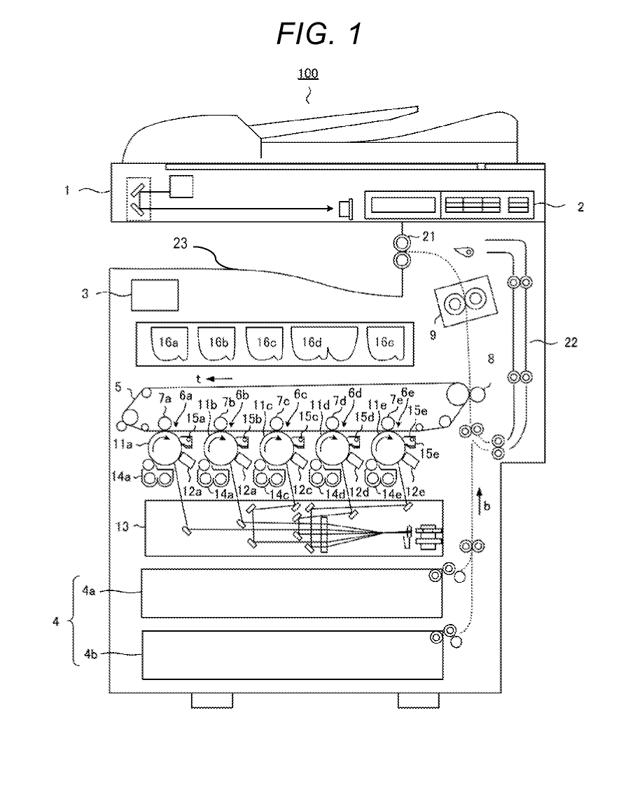

FIG. 1 is a schematic configuration diagram of an image forming apparatus according to a first embodiment. An MFP (Multi-Functional Peripheral) 100 is an image forming apparatus employing a 5-drum tandem process. The MFP 100 includes a scanner 1 which scans an original, a control panel 2 serving as an operation unit, and a control unit 3 which controls the processing operations of the MFP 100. A sheet feed unit 4 is disposed at a lower side of the MFP 100. The sheet feed unit 4 includes accommodation units 4a and 4b which store sheets of different sizes, as recording media. Between the scanner 1 and the sheet feed unit 4, the MFP 100 also contains an intermediate transfer belt 5 which is movable in the direction of the arrow t shown in FIG. 1. Five image forming units 6a, 6b, 6c, 6d, and 6e are disposed along the periphery of the intermediate transfer belt 5.

The image forming units 6a, 6b, 6c, 6d, and 6e form an image with a non-decolorizable yellow toner (hereafter also referred to as the “Y toner”), a non-decolorizable magenta toner (hereafter also referred to as the “M toner”), a non-decolorizable cyan toner (hereafter also referred to as the “C toner”) and a non-decolorizable black toner (hereafter also referred to as the “BK toner”), which are all non-decolorizable recording materials with no decolorizing function, and with a decolorizable blue toner (hereafter also referred to as the “E toner”), which is a decolorizable recording material with a decolorizing function.

Transfer rollers 7a, 7b, 7c, 7d, and 7e, each of which functions as a transfer unit and transfers a toner image formed by the image forming units 6a, 6b, 6c, 6d, and 6e onto the intermediate transfer belt 5, are disposed so as to face the image forming units 6a, 6b, 6c, 6d, and 6e, respectively, with the intermediate transfer belt 5 being disposed therebetween. A secondary transfer roller 8 transfers a toner image formed by at least one of the image forming units 6a, 6b, 6c, 6d, and 6e on sheet fed from the sheet feed unit 4 onto the intermediate transfer belt 5. The secondary transfer roller 8 is disposed downstream with respect to the image forming unit 6e along the movement direction of the intermediate transfer belt 5. A fuser unit 9 which fuses a toner image onto the sheet is disposed downstream with respect to the secondary transfer roller 8 along the conveying direction (the direction of the arrow b shown in FIG. 1) of the sheet fed from the sheet feed unit 4.

The image forming units 6a, 6b, 6c, 6d, and 6e have substantially the same configuration except for the toner accommodated therein. Therefore, hereinafter, the configuration of the image forming unit 6a is described as an example of the configuration of each of the image forming units 6a, 6b, 6c, 6d, and 6e.

The image forming unit 6a includes a photosensitive drum 11a which serves as an image carrier. A charger 12a which charges the photosensitive drum 11a, an exposure apparatus 13 which irradiates the charged photosensitive drum 11a with a laser beam scan line according to image information, and a developing device 14a which accommodates the non-decolorizable Y toner and develops an electrostatic latent image formed by the exposure apparatus 13 are disposed in a periphery of the photosensitive drum 11a. Furthermore, the image forming unit 6a includes a cleaning apparatus 15a which removes residual toner on the photosensitive drum 11a after the toner image on the photosensitive drum 11a is transferred by the transfer roller 7a.

Similarly, the image forming units 6b, 6c, 6d, and 6e include photosensitive drums 11b, 11c, 11d, and 11e, chargers 12b, 12c, 12d, and 12e, the exposure apparatus 13, developing devices 14b, 14c, 14d, and 14e, and cleaning apparatuses 15b, 15c, 15d, and 15e, respectively. The toner accommodated in the developing device 14b is the non-decolorizable M toner, the toner accommodated in the developing device 14c is the non-decolorizable C toner, the toner accommodated in the developing device 14d is the non-decolorizable BK toner, and the toner accommodated in the developing device 14e is the decolorizable E toner.

The developing devices 14a, 14b, 14c, 14d, and 14e each detect toner density accommodated therein. According to the toner density, the developing devices 14a, 14b, 14c, 14d and 14e each receive a supply of toner from toner cartridges 16a, 16b, 16c, 16d, and 16e which correspond to the respective toners accommodated in the developing devices.

The image forming units 6a, 6b, 6c, 6d, and 6e can switch modes of image formation (hereafter, also referred to as “printing”). That is, printing with the decolorizable recording material having a decolorizing function or printing with the non-decolorizable recording material having no decolorizing function can be switched. When printing is performed with the decolorizable recording material, in order to prevent color mixing with the non-decolorizable recording material, the image forming unit 6e (the photosensitive drum 11e) contacts the intermediate transfer belt 5, and the image forming units 6a, 6b, 6c, and 6d (the photosensitive drums 11a, 11b, 11c, and 11d) are apart from the intermediate transfer belt 5. When printing is performed with the decolorizable recording material having the decolorizing function, the temperature of the fuser unit 9 is controlled so as to be equal to or higher than the fusing temperature and lower than the decolorizing temperature of the decolorizable recording material.

Meanwhile, when printing is performed with the non-decolorizable recording material having no decolorizing function, the image forming units 6a, 6b, 6c, and 6d (the photosensitive drum 11a, 11b, 11c, and 11d) contact the intermediate transfer belt 5. In addition, the temperature of the fuser unit 9 is controlled so as to be equal to or higher than the fusing temperature of the non-decolorizable recording material.

A flapper (a junction member) is provided downstream with respect to the fuser unit 9 in the conveying direction. The flapper allocates sheet fed thereto in the direction of a discharge roller 21 or in the direction of a re-transport unit 22. The sheet guided to the discharge roller 21 is discharged to a discharge unit 23. In addition, the sheet guided to the re-transport unit 22 is guided in the direction of the secondary transfer roller 8.

Furthermore, since the configuration shown in FIG. 1 is a color MFP, the image forming units 6a, 6b, 6c, and 6d each containing different non-decolorizable recording material are disposed. However, the image forming apparatus may include only the image forming units 6d and 6e and only use the non-decolorizable recording material BK toner and the decolorizable recording material E toner for printing.

There are no particular limitations to the non-decolorizable recording material toners of the present embodiment which are recording materials with no decolorizing function. Therefore, a toner may be used which contains well-known non-decolorizable toner particles of the related art containing colorant, binder resin, and the like, and an additive added to the surface of the toner particles as necessary. Furthermore, when using a two-component developing device, the toner and the carrier are mixed. Well-known pigments such as carbon black, polycyclic dye, azo pigment, phthalocyanine pigment, and inorganic pigment, and dye, and the like can be used as the colorant. Polyester resin, styrene-acrylic resin, and the like can be used as the binder resin. In addition, wax may be added to the toner particles as a fusing promoter. A charge control agent (CCA) may also be added to the toner particles. Among such non-decolorizable toners, when the fusing temperature and the decolorizing temperature of the decolorizable toner accommodated in the developing device 14e are taken into consideration, using a non-decolorizable toner with approximately the same fusing temperature as the decolorizable toner is preferable.

In addition, the decolorizable blue toner of the present embodiment, which is a recording material having a decolorizing function, may bring a reversible color-forming or decolorizing reaction in which decolorizing occurs at a specific temperature (the decolorizing temperature) or higher, and color-forming occurs when the temperature drops to a specific temperature (a recolor temperature) or lower. Such a decolorizing toner contains at least a decolorizable coloring material and a binder resin. Additionally, the decolorizable toner may also contain wax, a charge control agent, or the like as necessary. Furthermore, an external additive, which is distinct from the toner particles, may also be mixed in. For the binder resin, a polyester resin with a low glass transition temperature is used from the viewpoint of low temperature fusing.

There are no particular limitations to the decolorizable color material, as long as the color material is a coloration compound having a structure which decolorizes when the temperature is raised by heating and recolorizes through cooling. However, leuco dye is used as a generally well-known color material. The leuco dye is appropriately combined with a developer, a decolorizing agent, a color changing temperature adjustment agent, and the like, and a configuration is selected such that coloring vanishes at a fixed temperature or higher and recoloring occurs at a fixed temperature or lower. Description will be given of the coloration compounds such as leuco dye, the developers and the decolorizing agents below.

Leuco dye is an electron-donating compound capable of forming color using a developer. Examples thereof include diphenylmethanephthalides, phenylindolylphthalides, indolylphthalides, diphenylmethaneazaphthalides, phenylindolylazaphthalides, fluorans, styrylquinolines, and diazarhodaminelactones.

Specific examples include 3,3-bis(p-dimethylaminophenyl)-6-dimethylaminophthalide, 3-(4-diethylaminophenyl)-3-(1-ethyl-2-methylindole-3-yl)phthalide, 3,3-bis(1-n-butyl-2-methylindole-3-yl)phthalide, 3,3-bis(2-ethoxy-4-diethylaminophenyl)-4-azaphthalide, 3-(2-ethoxy-4-diethylaminophenyl)-3-(1-ethyl-2-methylindole-3-yl)-4-azaphthalide, 3-[2-ethoxy-4-(N-ethylanilino)phenyl]-3-(1-ethyl-2-methyl indole-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutyl-amino)fluoran, 1,2-benz-6-(N-ethyl-N-isoamyl-amino)fluoran, 2-(3-methoxy-4-dodecoxystyryl)quinoline, spiro[5H-(1)benzopyrano(2,3-d)pyrimidine-5,1′(3′H) isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-i-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindole-3-yl)-4,5,6,7-tetrachlorophthalide, 3-(2-ethoxy-4-diethylaminophenyl)-3-(1-ethyl-2-methylindole-3-yl)-4,5,6,7-tetrachlorophthalide and 3-(2-ethoxy-4-diethylaminophenyl)-3-(1-pentyl-2-methylindole-3-yl)-4,5,6,7-tetra-chloro-phthalide. Further examples include pyridine-based, quinazoline-based and bisquinazoline-based compounds. A mixture of two or more of the compounds exemplified above may also be used.

The developer is an electron-accepting compound which provides protons to the leuco dye. Examples of the developing device include phenols, phenol metal salts, carboxylic acid metal salts, aromatic carboxylic acids, aliphatic carboxylic acids with 2 to 5 carbon atoms, benzophenones, sulfonic acids, sulfonic acid salts, phosphoric acids, phosphoric acid metal salts, acid phosphate esters, acid phosphate ester metal salts, phosphorous acids, phosphorous acid metal salts, monophenols, polyphenols, 1,2,3-triazoles and derivatives thereof. Further examples of the developing device include substituents which may include alkyl groups, aryl groups, acyl groups, alkoxycarbonyl groups, carboxy groups and esters thereof or amide groups, halogen group and the like. In addition, bis-type or tris-type phenols and the like, phenol-aldehyde condensation resins and the like, and the metal salts thereof may be exemplified. A mixture of two or more of the compounds exemplified above may also be used.

Specific examples include phenol, o-cresol, t-butyl catechol, nonylphenol, n-octylphenol, n-dodecylphenol, n-stearylphenol, p-chlorophenol, p-bromophenol, o-phenylphenol, p-hydroxybenzoic acid n-butyl, p-hydroxybenzoic acid n-octyl, p-hydroxybenzylbenzoate, dihydroxybenzoic acid or esters thereof, for example, 2,3-dihydroxybenzoic acid, 3,5-dihydroxybenzoic acid methyl, resorcinol, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethylpropionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl) n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol and methylenetris-p-cresol.

In the three compound system of the coloration compound, the developer, and the decolorizing agent, as long as the decolorizing agent can decolorize the color by impeding a color-forming reaction between the coloration compound and the developer using heat, any well-known decolorizing agent may be used. Examples of the decolorizing agent include alcohols, esters, ketones, ethers, and amino acids. A mixture of two or more of the compounds exemplified above may also be used.

Furthermore, in the above embodiment the toners are described as decolorizable recording materials and non-decolorizable recording materials. However, according to the mode of the image forming apparatus, liquid ink, gel ink, an ink ribbon, or the like may be used. In addition, the MFP 100 may include the functions of a decolorizing apparatus 200 described below.

With respect to the sheet printed with decolorizable recording material by the image forming apparatus described above, the color of the decolorizable recording material on the sheet can be decolorized, for example, by the decolorizing apparatus 200 described below.

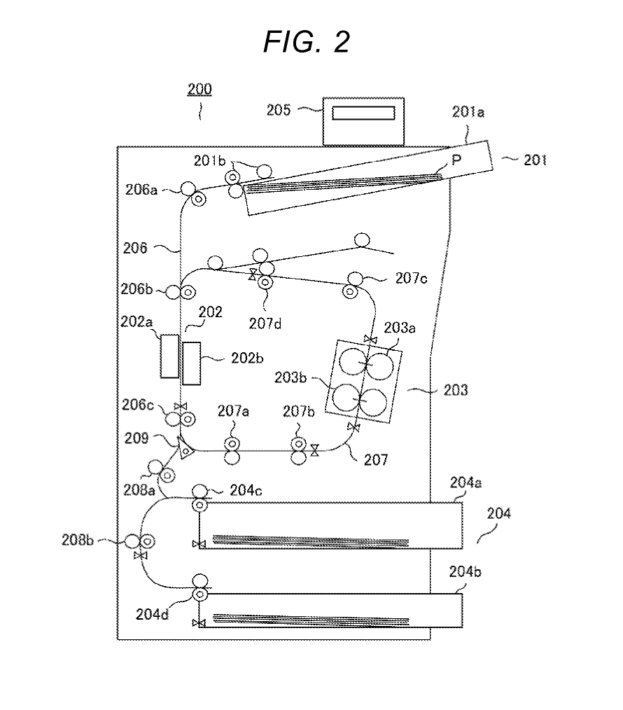

FIG. 2 is a schematic diagram showing the whole configuration of the decolorizing apparatus 200. The decolorizing apparatus 200 is an apparatus which decolorizes the color on a sheet P with heat or the like. The color on the sheet P is printed with a decolorizable recording material of the image forming apparatus 100 of the present embodiment, for example, a decolorizable toner, a decolorizable ink, or the like. The decolorizing apparatus 200 includes an operation unit 205 which operates the processes of a sheet feed unit 201, a reading unit 202, a decolorizing unit 203, a discharged sheet storage unit 204, and the decolorizing apparatus 200.

The sheet feed unit 201 includes a sheet feed tray 201a and a sheet feed and transport roller 201b. The sheet P which is printed with the decolorizable recording material or the like is stacked on the sheet feed tray 201a. The sheet P is fed to a first transport path 206 by the sheet feed and transport roller 201b, and is fed to the reading unit 202 by transport rollers 206a and 206b.

The reading unit 202 includes a front surface reading unit 202a which reads the front surface (the first surface) of the sheet P transported thereto and a rear surface reading unit 202b which reads the rear surface (the second surface) of the sheet P. Here, the information read out from the sheet P is accumulated within the decolorizing apparatus, or is accumulated in a separate storage apparatus via a communication line.

After passing through the reading unit 202, the sheet P passes through a transport roller 206c, is subsequently guided to a second transport path 207 by the flapper (the junction member), and is conveyed to the decolorizing unit 203 by transport rollers 207a and 207b.

The decolorizing unit 203 includes a first heating and conveying members 203a and a second heating and conveying members 203b both of which pinch and convey the sheet P. The first and the second heating transport members 203a and 203b decolorize the color of an image or the like printed on the sheet P by heating the sheet P to a predetermined decolorizing temperature. After passing through the decolorizing unit 203, the sheet P is conveyed to the reading unit 202 by transport rollers 207c, 207d, and 206b, and the surfaces of the sheet are read again. Then, it is determined whether or not a portion of the image remains without being erased, whether or not the sheet is ripped, folded or the like, and whether or not the sheet P is reusable.

The discharged sheet storage unit 204 includes a reusable sheet storage tray 204a and a non-reusable sheet storage tray 204b. After the surface of the sheet P is read again by the reading unit 202, the sheet P passes through the transport roller 206c and is subsequently guided to a third transport path 208 by a flapper (a junction member) 209. After being determined to be reusable, a sheet P1 passes through a transport roller 208a and is subsequently discharged to the reusable sheet storage tray 204a by a first discharge and transport roller 204c. Meanwhile, after a sheet P2 is determined to be non-reusable, a rotational direction of the discharge and transport roller 204c is reversed and the sheet P2 is conveyed by the transport roller 208b and discharged to the non-reusable sheet storage tray 204 by a discharge and transport roller 204d. Furthermore, the reusable sheet storage tray 204a and the non-reusable sheet storage tray 204b may exchange the sheets which the respective trays are to receive. The transport destination of the sheet P may be set with the operation unit 205, for example.

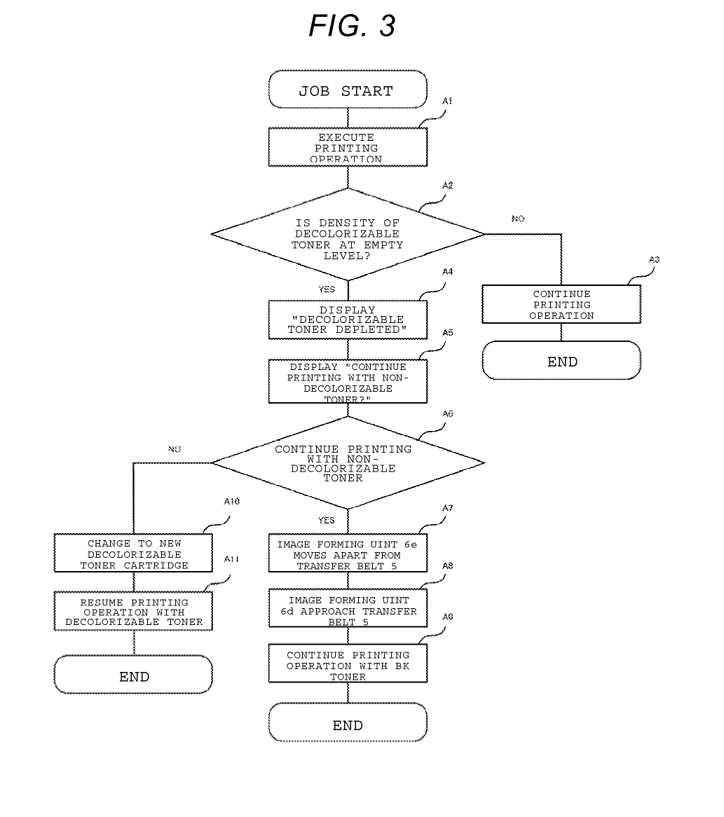

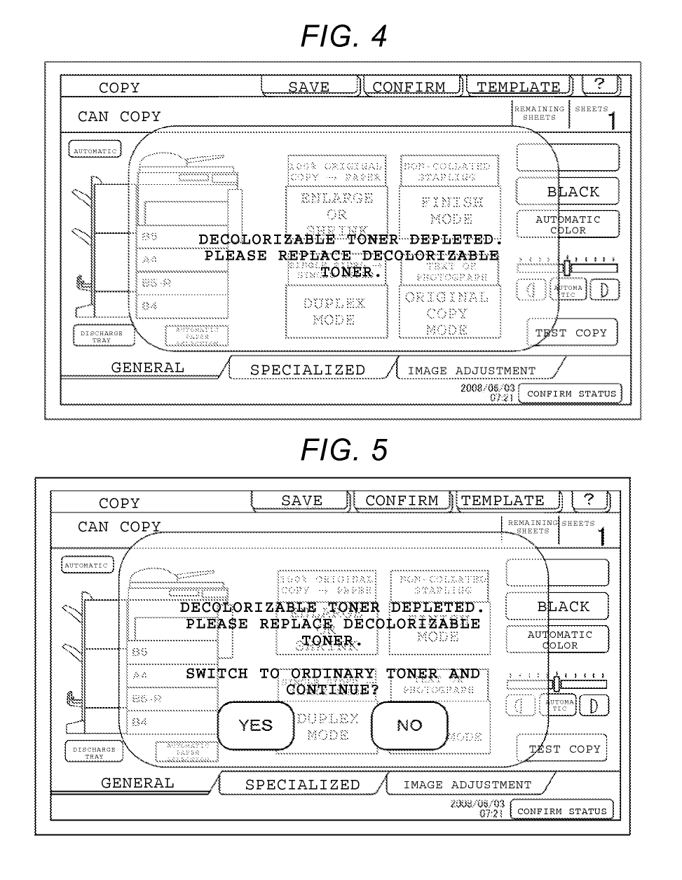

Next, the operation of the image forming apparatus according to the present embodiment is described with reference to FIGS. 3 to 5. The operation processing of the image forming apparatus is controlled by the control unit 3. FIG. 3 is a flowchart showing an example of the operation of the image forming apparatus of the present embodiment. FIGS. 4 and 5 are examples of interfaces displayed on a control panel when the operation in FIG. 3 is performed.

As shown in FIG. 3, first, if a printing operation (an image formation operation) with decolorizable material is started in the image forming apparatus of the present embodiment (A1), the density of the decolorizable toner within the developing device is detected during the execution of the printing operation and whether or not the density reaches an empty level is determined (A2). If the detected density does not reach an empty level, the printing operation continues uninterrupted (A3) and the process ends.

Meanwhile, as shown in FIG. 4, if the density reaches an empty level, a message that the decolorizable toner is empty is displayed on the control panel (A4). Furthermore, as shown in FIG. 5, an inquiry of whether or not to continue printing with ordinary toner (non-decolorizable toner) is displayed on the control panel (A5). Here, whether or not to continue printing with the ordinary toner is selected by the user (A6). If the user selects the printing with the ordinary toner (A6 Yes), the image forming unit 6e (the photosensitive drum 11e) moves apart from the intermediate transfer belt 5 (A7). Subsequently, the image forming unit 6d (the photosensitive drum 11d) approaches the intermediate transfer belt 5 and the printing operation with the BK toner is continued (A8 and A9).

Meanwhile, if the printing with the ordinary toner is not selected (A6 No), then the printing operation is interrupted and the user exchanges the empty toner cartridge with a new decolorizable toner cartridge (A10). Subsequently, the printing operation with the decolorizable toner is resumed (A11).

The color of the non-decolorizable toner is not particularly limited. However, when toner with a color close to the color of the decolorizable toner is selected, distinction between the decolorizable toner and the non-decolorizable toner is not easy and misrecognition of the toners by the user may occur. Therefore, printing using a toner of a color different than the color of the decolorizable toner is preferable.

In the present embodiment, documents printed with decolorizable toner and documents printed with non-decolorizable toner are both discharged to the same tray. However, since the documents are separated into reusable sheet and non-reusable sheet by the separating function of the decolorizing apparatus described above, the presence of both types of document does not interfere with the repeated usage of the sheets.

In addition, as another embodiment, there is an image forming apparatus in which the image forming unit containing a non-decolorizable recording material and the image forming unit containing a decolorizable recording material both operate so as to print the non-decolorizable recording material and the decolorizable recording material onto the same sheet according to the respective uses thereof. The image forming apparatus may be used to continue the printing operation by, during printing, when the decolorizable recording material is used up and there is no stock thereof, a portion to be printed with the decolorizable recording material (hereafter referred to as the “decolorizable recording material image formation region”) is printed with the non-decolorizable recording material. In addition, as yet another embodiment, there is also a configuration in which the image forming apparatus may be used to continue the printing operation without printing the decolorizable recording material image formation region.

As described above, according to the image forming apparatus of the present embodiment, printing with the decolorizable recording material and the non-decolorizable recording material may be switched arbitrarily or automatically. In addition, during printing with the decolorizable recording material, for example, when the decolorizable recording material is used up and there is no stock thereof, there may be a problem in that the printing operation with the decolorizable recording material may not be continued quickly. In order to solve such a problem, the printing operation may be continued by switching to printing with the non-decolorizable recording material.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a first image forming unit configured to form an image on a medium with a non-decolorizable material;
a second image forming unit configured to form an image on a medium with a decolorizable material; and
a control unit configured to form the image on the medium with the non-decolorizable material in response to a printing command to form the image on the medium with the decolorizable material.

2. The image forming apparatus according to claim 1, wherein the control unit is configured to determine whether or not a sufficient amount of the decolorizable material is stored in a storing unit for the second image forming unit to form the image on the medium with the decolorizable material when the printing command to form the image on the medium with the decolorizable material is received.

3. The image forming apparatus according to claim 2, wherein the control unit is configured to control a display to display a message indicating that the decolorizable material is unavailable in sufficient amount and prompt a user to input whether or not the non-decolorizable material is to be used instead of the decolorizable material, and control the second image forming unit to form the image in response to receiving the instruction to use the non-decolorizable material instead of the decolorizable material.

5. The image forming apparatus according to claim 1, wherein a color of an image formed with the decolorizable material is different from a color of an image formed with the non-decolorizable material.

6. The image forming apparatus according to claim 1, wherein a color of an image formed with the non-decolorizable material is black.

7. The image forming apparatus according to claim 1, wherein the first image forming unit and the second image forming unit are configured to form images on a single medium.

8. The image forming apparatus according to claim 1, further comprising:
a transfer unit from which the image of the decolorizable material and the image of the non-decolorizable material are transferred onto a medium,
wherein the control unit is configured to move the first image forming unit closer to the transfer unit when the first image forming unit is used for the image forming, and move the second image forming unit closer to the transfer unit when the second image forming unit is used for the image forming.

9. The image forming apparatus according to claim 1, further comprising:
a sensor configured to determine a density of the decolorizable material stored in the storing unit,
wherein the control unit is configured to detect whether or not a sufficient amount of the decolorizable material is stored in the storing unit according to the detected density.

10. The image forming apparatus according to claim 9, wherein the control unit is configured to determine that the amount of the decolorizable material stored in the storing unit is not sufficient if the detected density is less than a predetermined value.

11. An image forming apparatus, comprising:
a first image forming unit configured to form an image on a medium with a non-decolorizable material;
a second image forming unit configured to form an image on a medium with a decolorizable material; and
a control unit configured to determine whether or not a sufficient amount of the decolorizable material is stored in a storing unit for the second image forming unit to form the image on the medium with the decolorizable material in response to a printing command to form the image on the medium with the decolorizable material, and to form the image on the medium using the first image forming unit with the non-decolorizable material if the control unit determines that an insufficient amount of the decolorizable material is stored in the storing unit for the second image forming unit to form the image on the medium with the decolorizable material.

12. The image forming apparatus according to claim 11, wherein the control unit is configured to control a display to display a message indicating that the decolorizable material is unavailable in sufficient amount and prompt a user to input whether or not the non-decolorizable material is to be used instead of the decolorizable material, and control the second image forming unit to form the image in response to receiving the instruction to use the non-decolorizable material instead of the decolorizable material.

13. The image forming apparatus according to claim 11, wherein a color of an image formed with the decolorizable material is different from a color of an image formed with the non-decolorizable material.

14. The image forming apparatus according to claim 11, wherein the first image forming unit and the second image forming unit are configured to form images on a single medium.

15. The image forming apparatus according to claim 11, further comprising:
a sensor configured to detect a density of the decolorizable material stored in the storing unit,
wherein the control unit is configured to determine whether or not a sufficient amount of the decolorizable material is stored in the storing unit according to the detected density.

16. A method for operating an image forming apparatus including a first image forming unit configured to form an image on a medium with a non-decolorizable material and a second image forming unit configured to form an image on a medium with a decolorizable material, the method comprising:
in response to a printing command to form an image on a medium with the decolorizable material, determining whether or not the decolorizable material is available in sufficient amount for printing the image on the medium; and
forming the image with the first image forming unit with the non-decolorizable material if the decolorizable material is determined to be unavailable in sufficient amount for printing the image on the medium.

17. The method according to claim 16, further comprising:
forming the image with the second image forming unit if the decolorizable material is determined to be available in sufficient amount for printing the image on the medium.

18. The method according to claim 17, further comprising:
controlling a display to display a message indicating that the decolorizable material is unavailable in sufficient amount and prompt a user to input whether or not the non-decolorizable material is to be used instead of the decolorizable material, and
controlling the second image forming unit to form the image in response to receiving the instruction to use the non-decolorizable material instead of the decolorizable material.

19. The method according to claim 16, wherein a color of an image formed with the decolorizable material is different from a color of an image formed with the non-decolorizable material.

20. The method according to claim 16, wherein the first image forming unit and the second image forming unit are configured to form images on a single medium.
